(19) United States
(12) Patent Application Publication
(10) Pub. No.: US 2016/0318500 A1
(43) Pub. Date: Nov. 3, 2016

(54) Device and Method for Controlling Torque Intervention of a Hybrid Vehicle

(71) Applicant: HYUNDAI MOTOR COMPANY, Seoul (KR)

(72) Inventors: Hyung Seuk Ohn, Gyeonggi-do (KR); Neung Seop Ohn, Seoul (KR); Seong Yeop Lim, Seoul (KR); Jong Ho Lee, Gyeonggi-do (KR)

(73) Assignee: HYUNDAI MOTOR COMPANY, Seoul (KR)

(21) Appl. No.: 14/937,516

(22) Filed: Nov. 10, 2015

(30) Foreign Application Priority Data
Apr. 29, 2015 (KR) 10-2015-0060486

(51) Int. Cl. B60W 20/10; B60K 6/20; B60W 10/11; B60L 15/20; B60W 10/06; B60W 10/08

(52) U.S. Cl. CPC B60W 20/10; B60W 10/06; B60W 10/08; B60W 10/11; B60L 15/20; B60K 6/20; B60W 2510/244; B60W 2540/16; B60W 2710/0666; B60W 2710/083; B60W 2710/1005; Y10S 903/93; B60Y 2200/92; B60Y 2300/43; B60Y 2300/1886; B60Y 2300/60; B60Y 2300/70

(57) ABSTRACT

The present invention relates to devices for controlling torque intervention for reducing input torque of a transmission at the time of an upshift operation of a hybrid vehicle, and more particularly, to devices and methods for controlling torque intervention of a hybrid vehicle, which selectively perform the torque intervention of a motor of the hybrid vehicle or the torque intervention of the motor and an engine. Device and methods for controlling torque intervention of a hybrid vehicle may receive an upshift command from a driver in a hybrid traveling mode, compare an amount of requested torque intervention according to the upshift command with an amount of performing torque intervention of a motor, and selectively perform the torque intervention of the motor or the torque intervention of the motor and an engine.

### RELATED APPLICATIONS

This application claims the benefit of Korean Patent Application No. 10-2015-0060486, filed on Apr. 29, 2015, the entire contents of which are incorporated herein by reference.

### BACKGROUND OF THE INVENTION

1. Field of the Invention

The present disclosure relates to devices and methods for controlling torque intervention of a hybrid vehicle. More particularly, it relates to a technology that variably controls intervention of a motor for each voltage of a high-voltage battery of a hybrid vehicle using properties of the motor in a hybrid traveling mode of the vehicle.

2. Description of the Related Art

Recently, interests are focused on environmentally-friendly vehicles due to a worldwide trend to meet stricter exhaust gas emission regulations for vehicles as a concern about environmental problems has increased. Vehicle manufacturers mass-produce and manufacture hybrid vehicles for reflecting the interests in the environmentally-friendly vehicles.

In a narrow sense, the hybrid vehicle may be distinguished from a fuel cell vehicle and an electric vehicle, but in the present specification, the hybrid vehicle refers to a vehicle that uses an engine and a motor as power sources. That is, the hybrid vehicle includes a hybrid traveling mode, that is, an engine driving mode, and an electric traveling mode, that is, a motor driving mode.

Control units are provided in the hybrid vehicle for each device that constitutes a system, and there are provided a hybrid control unit (HCU) which controls overall operations of the hybrid vehicle, an engine control unit (ECU) which controls overall operations of the engine, a motor control unit (MCU) which controls overall operations of the drive motor, a transmission control unit (TCU) which controls a transmission, and a battery management system (BMS) which monitors and manages a state of a battery. Among the control units, the transmission control unit requests torque intervention in order to prevent an excessive increase in engine speed or impact at the time of a gear shift operation, and to protect the transmission.

As described above, since the hybrid vehicle uses driving power from the engine and the motor, there are problems in that in a case in which only the engine is used as an object that performs torque intervention of the transmission for a vehicle in the related art, due to torque intervention of the engine which performs a delayed ignition, fuel consumption is increased, and driving performance of a driver deteriorates due to the delayed ignition.

There is a drawback in that in a case in which input torque of the transmission is high at the time of an upshift operation of the hybrid vehicle that travels in a hybrid mode, time required for a gear shift operation is increased. Therefore, a method of performing the torque intervention of the transmission is under discussion.

In order to solve the problem in view of the time required for a gear shift operation is increased because input torque of the transmission is high, Korean Patent Application Laid-Open No. 10-2011-0139611 provides a technology that analyzes a driving request, calculates input torque of a transmission, and controls an operating point of an engine depending on the input torque by using an engine control means.

However, the aforementioned technology, which controls the input torque of the transmission by using the engine control means, has problems in that an ignition timing of the engine is delayed, and as a result, output efficiency of the engine deteriorates, and fuel efficiency is decreased due to the delayed ignition.

FIG. 1 illustrates a delay of an ignition timing due to the torque intervention of the engine of the vehicle, and an amount of torque of the vehicle corresponding to the delay of the ignition timing. FIG. 1 illustrates that when the torque intervention of the engine is performed, output efficiency of the engine and fuel efficiency of the engine are decreased due to the delay of the ignition timing.

The above information disclosed in this Background section is only for enhancement of understanding the background of the invention and therefore it may contain information that does not form the prior art that is already known in this country to a person of ordinary skill in the art.

### SUMMARY OF THE INVENTION

The present disclosure has been made in an effort to solve the above-described problems associated with the prior art, and to provide devices for controlling torque intervention of a hybrid vehicle, which compares an amount of torque intervention of a motor according to a state of charge of a battery and an amount of torque intervention by a request from a driver, and selectively performs the torque intervention of the motor or the torque intervention of the motor and an engine.

The present disclosure has also been made in an effort to provide devices for controlling torque intervention of a hybrid vehicle, which prevents a deterioration in output of an engine and improves fuel efficiency and driving performance of a driver by performing torque intervention by simultaneously using a motor and an engine.

The objects of the present disclosure are not limited to the aforementioned objects, and other objects of the present disclosure, which are not mentioned above, may be clearly understood from the following descriptions and may become apparent from the exemplary embodiments of the present invention. In addition, the objects of the present disclosure may be implemented by means and a combination thereof disclosed in the claims.

In one aspect, the present disclosure provides a device for controlling torque intervention of a hybrid vehicle, including: an engine which provides torque intervention at the time of a gear shift operation of the vehicle; a motor which is connected with a battery of the vehicle and provides torque intervention at the time of the gear shift operation of the vehicle depending on a state of charge of the battery; and a control unit which performs the torque intervention depending on an amount of requested torque intervention of the vehicle, in which the control unit transmits a gear upshift command depending on the state of charge of the battery, an amount of intervention of the motor according to the state of charge of the battery, a traveling state of the vehicle, and a request from a driver, measures the amount of requested torque intervention of the vehicle according to the gear upshift command, compares the amount of requested torque intervention with the amount of intervention of the motor, and selectively performs the intervention of the motor or the torque intervention of the motor and the engine.

In a preferred implementation, when the vehicle travels in a hybrid mode, the control unit may compare the amount of torque intervention, which is provided by the motor depending on the state of charge of the battery, with the amount of requested torque intervention according to the gear upshift command, and may perform the intervention using the motor when the amount of requested torque intervention is smaller than the amount of torque intervention of the motor.

In another preferred implementation, when the vehicle travels in a hybrid mode, the control unit may compare the amount of torque intervention, which is provided by the motor depending on the state of charge of the battery, with the amount of requested torque intervention according to the gear upshift command, and may perform the torque intervention using the motor and the engine when the amount of requested torque intervention is larger than the amount of torque intervention of the motor.

In yet another preferred implementation, when the control unit performs the torque intervention using the engine, the control unit may perform the torque intervention of the engine depending on a difference between the amount of requested torque intervention according to the upshift operation and the amount of torque intervention of the motor.

In still another preferred implementation, the control unit may include a hybrid control unit (HCU), an engine control unit (ECU), a motor control unit (MCU), and a transmission control unit (TCU).

In another aspect, the present disclosure provides methods of controlling torque intervention of a hybrid vehicle that include: receiving, by a transmission control unit, an amount of requested torque intervention; calculating, by a motor control unit, an amount of torque intervention provided by a motor; receiving and comparing, by a hybrid control unit, the amount of requested torque intervention and the amount of torque intervention of the motor; and selectively performing the intervention of the motor or the torque intervention of the motor and an engine in the comparing of the amount of torque intervention.

In a preferred implementation, when the amount of requested torque intervention is smaller than the amount of torque intervention of the motor in the comparing of the amount of torque intervention, the motor may perform the intervention.

In another preferred implementation, when the amount of requested torque intervention is larger than the amount of torque intervention of the motor in the comparing of the amount of torque intervention, the motor and the engine may perform the intervention.

In yet another preferred implementation, when the motor and the engine perform the intervention, the torque intervention of the engine may be performed depending on a difference between the amount of requested torque intervention according to an upshift operation and the amount of torque intervention of the motor.

According to the implementations described above, there is an effect of preventing a deterioration in output of the vehicle by selectively performing the torque intervention using the engine and the motor at the time of an upshift operation of the hybrid vehicle.

Regenerative braking of the motor is performed by selectively performing the torque intervention using the motor, and as a result, there is an effect of reducing fuel consumption in the hybrid vehicle.

Torque is quickly reduced by performing the torque intervention using the motor, and as a result, there is an effect of improving driving performance of the vehicle.

Other aspects and preferred embodiments of the invention are discussed infra.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles, e.g., fuel derived from resources other than petroleum. As referred to herein, a hybrid vehicle is a vehicle that has two or more sources of power, for example, both gasoline-powered and electric-powered vehicles.

The above and other features of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present invention, and wherein:

FIG. 1 illustrates a change in torque value due to a delay of ignition in a case in which an engine independently controls torque intervention in the related art;

FIG. 2 illustrates a block diagram of a configuration of a device for controlling torque intervention of a hybrid vehicle according to the present invention;

FIG. 3 illustrates sections in which driving power of a motor is output and regenerative braking is carried out in a case in which the motor for a hybrid vehicle independently controls torque intervention;

FIG. 4 illustrates a comparative view that compares an amount of performing motor intervention with an amount of actually requesting intervention in order to select an object to be subject to intervention of the present invention; and

FIG. 5 illustrates a flowchart in respect to a method of controlling torque intervention of the hybrid vehicle.

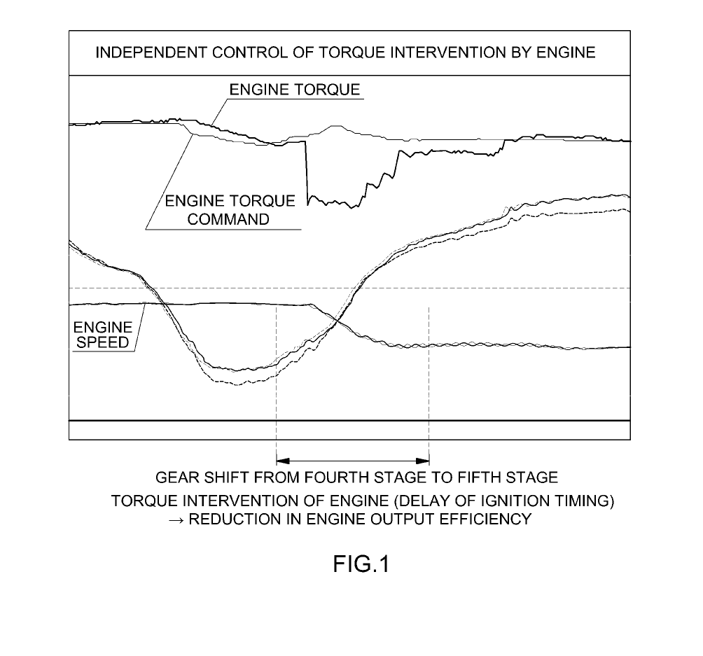

### Reference Numerals in Drawings

Reference numerals set forth in the Drawings include reference to the following elements as further discussed below:
10: hybrid control unit
20: engine control unit
30: motor control unit
40: transmission control unit
50: transmission
60: engine
70: engine clutch
80: motor
90: battery

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE PREFERRED EMBODIMENTS

Hereinafter, reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in more detail with reference to the accompanying drawings. The exemplary embodiments of the present invention may be modified to various forms, and the scope of the present invention should not be interpreted as being limited to the following exemplary embodiments. The present exemplary embodiments are provided to more completely explain the present invention to a person with ordinary skill in the art.

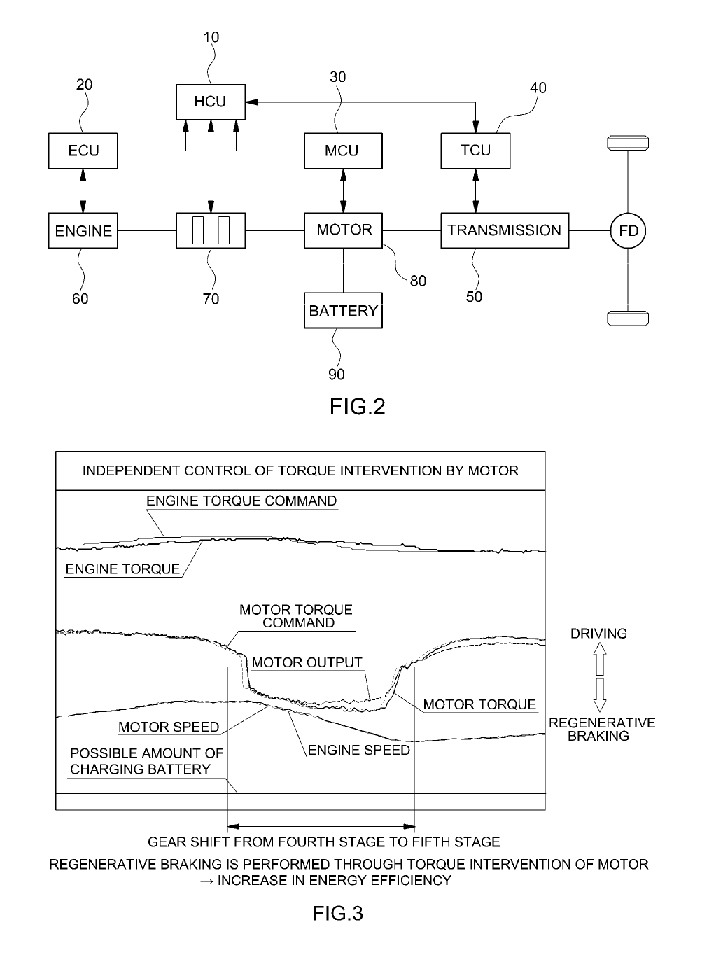

FIG. 2 is a schematic view illustrating a hybrid system to which a device for controlling torque intervention of a hybrid vehicle is applied.

The hybrid system in FIG. 2 is illustrated as an exemplary embodiment for ease of description. Therefore, the device for controlling torque intervention of a hybrid vehicle according to the exemplary embodiment and a method of controlling torque intervention may also be applied to all types of hybrid systems as well as the hybrid system in FIG. 2.

As illustrated in FIG. 2, the hybrid vehicle includes at least one engine, and at least one motor. In addition, the hybrid vehicle provides a traveling mode in which an engine and a motor are operated separately or simultaneously as a power source. That is, a traveling mode in which the engine and the motor are simultaneously operated as a power source is referred to as a hybrid traveling mode, and a traveling mode in which the vehicle is operated by the motor connected with the battery is referred to as an electric traveling mode.

The hybrid system of the present invention may include a hybrid control unit (HCU), an engine control unit (ECU), a motor control unit (MCU), a transmission control unit (TCU), an engine clutch, and a transmission.

The hybrid control unit (HCU) is a highest-ranked control unit that controls operations of other control units, sets hybrid driving modes, and controls overall operations of the hybrid vehicle. The hybrid control unit (HCU) sends and receives information to/from the respective control units, which are connected by high-speed CAN communication lines, and performs cooperative control to control output torque of the engine and the motor.

The engine control unit (ECU) controls overall operations of the engine depending on information about a state of the engine such as a torque signal requested by a driver, a temperature of a coolant, and engine torque.

The motor control unit (MCU) controls overall operations of the motor depending on a torque signal requested by the driver, driving modes of the hybrid vehicle, and a state of charge (SOC) of the battery.

The transmission control unit (TCU) controls a gear ratio depending on output torque of the engine control unit (ECU) and the motor control unit (MCU), and controls overall operations of the transmission, such as determining an amount of regenerative braking.

The control unit of the present invention is used as a concept including all of the hybrid control unit (HCU), the engine control unit (ECU), the motor control unit (MCU), and the transmission control unit (TCU).

The type of transmission includes transmissions such as an automatic transmission and a dual clutch transmission that may be generally applied to the vehicle. The dual clutch transmission is a transmission in which a mechanism of a manual transmission and convenience of the automatic transmission are combined. That is, the dual clutch transmission is a transmission in which two automated manual transmission clutches are present, the two clutches are connected with rotating shafts, respectively, and an odd-numbered stage gear and an even-numbered stage gear are provided separately, such that at the time of a gear shift operation, one clutch, which has been in contact with the gear, is separated, and then the other clutch connected to the other shaft comes into contact with the gear.

The device for controlling torque intervention allows an upshift operation to be quickly carried out at the time of an upshift operation of the transmission, and reduces impact produced in the transmission at the time of the gear shift operation, thereby improving driving performance of the driver.

Therefore, an upshift operation condition in which torque intervention of the hybrid vehicle is applied includes a condition in which driving input of the driver is generated when the vehicle travels in the hybrid traveling mode, that is, a general condition in which input of an acceleration pedal is present. As described above, in a case in which the vehicle travels in the hybrid traveling mode, the vehicle is operated by the engine and the motor, and in a case in which driving input of the vehicle is applied through input of the acceleration pedal from the driver, the transmission control unit calculates an amount of requested torque intervention that is required at the time of the upshift operation of the transmission.

The hybrid control unit serves to determine a torque intervention subject based on the amount of requested torque intervention of the vehicle that is calculated by the transmission control unit. The hybrid control unit serves to compare the amount of requested torque intervention of the vehicle, which is calculated by the transmission control unit, with an amount of torque intervention of the motor from the motor control unit, and selectively determines whether to perform the torque intervention of the motor or the torque intervention of the motor and the engine corresponding to the amount of requested torque intervention according to the upshift operation.

Whether to perform the torque intervention is determined by comparing the amount of requested torque intervention of the vehicle with the amount of torque intervention of the motor according to the state of charge of the battery. That is, in a case in which the amount of requested torque intervention of the vehicle is smaller than the amount of torque intervention of the motor according to the state of charge of the battery, the hybrid control unit performs the torque intervention of the motor. On the contrary, in a case in which the amount of requested torque intervention of the vehicle is larger than the amount of torque intervention of the motor according to the state of charge of the battery, the hybrid control unit performs the torque intervention of the motor and the engine.

More particularly, the amount of torque intervention of the motor may be determined according to the state of charge of the battery, and a maximum amount of torque intervention and a minimum amount of torque intervention of the motor may be determined depending on a maximum voltage and a minimum voltage of the battery.

FIG. 3 illustrates data obtained by performing the torque intervention of the motor.

As illustrated, in a section in which the transmission upshifts from a fourth stage to a fifth stage, engine torque is not reduced. However, FIG. 3 illustrates that as torque of the motor is lowered to a regenerative braking region, the torque intervention is performed. As described above, by performing the torque intervention of the motor, it is possible to minimize a region in which engine torque is reduced, and since a regenerative braking torque value is applied to the motor when performing the torque intervention of the motor, it is possible to improve fuel efficiency.

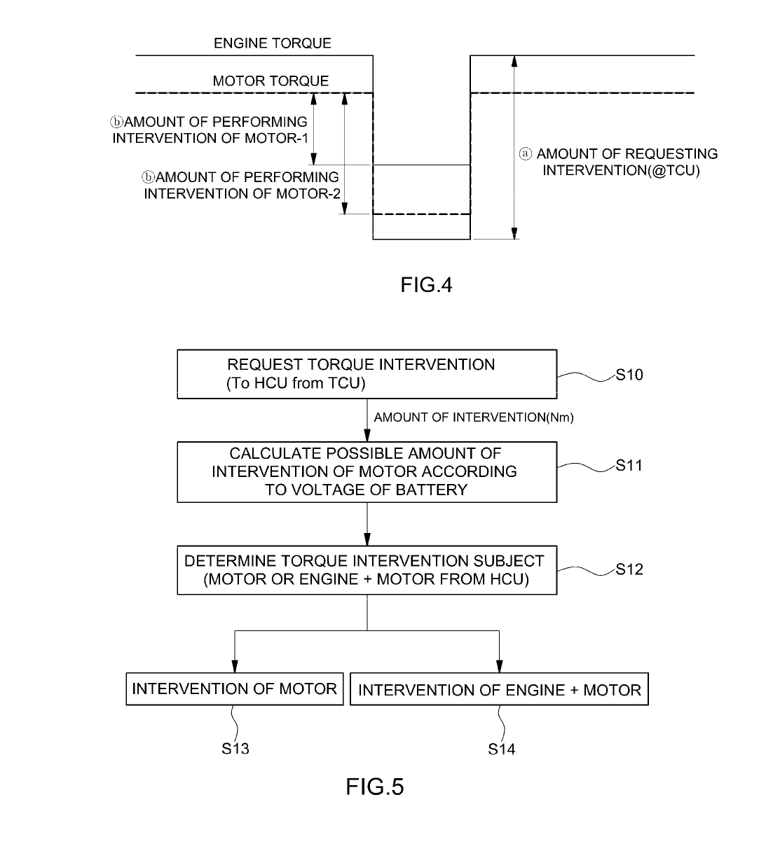

As the exemplary embodiment of the present invention, FIG. 4 illustrates minimum and maximum values of an amount of performing intervention of the motor according to the state of charge of the battery, and an amount of requesting intervention of the transmission at the time of the upshift operation.

As illustrated, the amount \textcircled{a} of requested torque intervention is calculated by the transmission control unit, and the amount \textcircled{b} of performing torque intervention of the motor is calculated by the motor control unit. The amount \textcircled{a} of requested torque intervention and the amount \textcircled{b} of performing torque intervention of the motor, which are calculated as described above, are compared with each other, and an object to be subject to the torque intervention is determined. The aforementioned comparison and determination are carried out by the hybrid control unit. Moreover, the motor control unit calculates the amount \textcircled{b} of performing torque intervention of the motor based on the state of charge of the battery, and as a result, the amount \textcircled{b} of performing torque intervention of the motor is determined depending on a voltage of the battery.

When determining an object to be subject to the torque intervention, in a case in which the amount \textcircled{a} of requested torque intervention is larger than the amount \textcircled{b} of performing torque intervention of the motor, the torque intervention of the engine is performed with respect to an amount (\textcircled{a}-\textcircled{b}) of requested torque intervention which is equal to or larger than the amount \textcircled{b} of performing torque intervention of the motor. More particularly, the torque intervention with respect to the amount (\textcircled{a}-\textcircled{b}) of requested torque intervention, which is larger than the maximum amount \textcircled{b} of torque intervention of the motor according to the state of charge of the battery, is performed by the engine.

Therefore, in the case in which the torque intervention of the engine is performed only with respect to the amount of requested torque intervention which is equal to and larger than the amount of torque intervention of the motor, it is possible to minimize torque intervention due to a delay of ignition of the engine, thereby improving fuel efficiency and driving performance of the driver.

FIG. 5 illustrates a flowchart of a method of controlling torque intervention of the hybrid vehicle.

In a case in which there is a request for the upshift operation of the transmission when the hybrid vehicle travels in the hybrid mode, the transmission control unit calculates the amount of requested torque intervention according to the request for the upshift operation of the transmission (S10). The hybrid control unit receives the calculated amount of requested torque intervention, and calculates the amount of performing torque intervention of the motor according to the state of charge of the battery (S11). Thereafter, the hybrid control unit compares the amount of torque intervention of the motor with the amount of requested torque intervention, and determines an object to be subject to the torque intervention (S12).

In a process of determining an object to be subject to the torque intervention, in a case in which the amount of torque intervention of the motor is larger than the amount of requested torque intervention, the torque intervention of the motor is performed (S13), and in a case in which the amount of torque intervention of the motor is smaller than the amount of requested torque intervention, the torque intervention of the engine, together with the torque intervention of the motor, is performed with respect to the amount of requested torque intervention which exceeds the torque intervention of the motor (S14).

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A device for controlling torque intervention of a hybrid vehicle, the device comprising:
an engine configured to provide torque intervention at a time of a gear shift operation of the vehicle;
a motor which is connected with a battery of the vehicle and is configured to provide torque intervention at the time of the gear shift operation of the vehicle depending on a state of charge of the battery; and
a control unit configured to perform the torque intervention using the motor and the engine depending on an amount of requested torque intervention of the vehicle,
wherein the control unit is configured to calculate the amount of torque intervention of the motor according to the state of charge of the battery, transmit a gear upshift command depending on a traveling state of the vehicle and a request from a driver, measure an amount of requested torque intervention of the vehicle according to a gear upshift command, compare the amount of torque intervention of the motor with the amount of requested torque intervention, and selectively perform the torque intervention of the motor or the torque intervention of the motor and the engine.

2. The device of claim 1, wherein when the vehicle travels in a hybrid mode, the control unit is configured to compare the amount of torque intervention of the motor, which is provided by the motor depending on the state of charge of the battery, with the amount of requested torque intervention according to the gear upshift command, and perform the intervention using the motor when the amount of requested torque intervention is smaller than the amount of torque intervention of the motor.

3. The device of claim 1, wherein when the vehicle travels in a hybrid mode, the control unit is configured to compare the amount of torque intervention of the motor, which is provided by the motor depending on the state of charge of the battery, with the amount of requested torque intervention according to the gear upshift command, and perform the torque intervention using the motor and the engine when the amount of requested torque intervention is larger than the amount of torque intervention of the motor.

4. The device of claim 3, wherein when the control unit performs the torque intervention using the engine, the control unit is configured to perform the torque intervention of the engine depending on a difference between the amount of requested torque intervention according to the upshift operation and the amount of torque intervention of the motor.

5. The device of claim 1, wherein the control unit includes a hybrid control unit (HCU), an engine control unit (ECU), a motor control unit (MCU), and a transmission control unit (TCU).

6. A method of controlling torque intervention of a hybrid vehicle, comprising:
receiving, by a transmission control unit, an amount of requested torque intervention;
calculating, by a motor control unit, an amount of torque intervention provided by a motor; and
receiving and comparing, by a hybrid control unit, the amount of requested torque intervention and the amount of torque intervention of the motor,
wherein when the amount of requested torque intervention is smaller than the amount of torque intervention of the motor in the comparing of the amount of requested torque intervention and the amount of torque intervention of the motor, the motor performs the intervention.

7. The method of claim 6, wherein when the amount of requested torque intervention is larger than the amount of torque intervention of the motor in the comparing of the amount of requested torque intervention and the amount of torque intervention of the motor, the motor and the engine perform the intervention.

8. The method of claim 7, wherein when the motor and the engine perform the intervention, the torque intervention of the engine is performed depending on a difference between the amount of requested torque intervention according to an upshift operation and the amount of torque intervention of the motor.
